(19) United States
(12) Patent Application Publication
(10) Pub. No.: US 2022/0280910 A1
(43) Pub. Date: Sep. 8, 2022

(54) MODIFIED CLAY, ITS PREPARATION AND USE

(71) Applicant: Mindbody Networks Inc., Fort Nelson (CA)

(72) Inventors: Hossein KAZEMIAN, Fort Nelson (CA); Robert C.W. CHEYNE, Fort Nelson (CA)

(21) Appl. No.: 17/686,394

(22) Filed: Mar. 3, 2022

Related U.S. Application Data
(60) Provisional application No. 63/157,399, filed on Mar. 5, 2021.

(51) Int. Cl. B01J 20/12; C02F 1/28; B01J 20/30; B01J 20/28

(52) U.S. Cl. CPC B01J 20/12; C02F 1/281; B01J 20/3085; B01J 20/28004; C02F 2101/38

(57) ABSTRACT

The specification relates to a clay having kaolinite from 20-40 wt. %; illite from 15-30 wt. %; pigeonite from 5-15 wt. %; and quartz up to a maximum of 40 wt. %. The clay is for use as an agent for reducing concentration of phosphorous in a fluid. Also disclosed is a process for preparation of a modified clay, and a method of treatment of a fluid using the clay or modified clay.

### CROSS-REFERENCE TO RELATED APPLICATIONS

This application claims the benefit of and priority to US Provisional Patent Application No. US 63/157,399 filed on Mar. 5, 2021 having the title MODIFIED CLAY, ITS USE AND PREPARATION. The content of the above patent application is hereby expressly incorporated by reference into the detailed description hereof.

### FIELD

The specification relates to clay or modified clay, for use in removal of phosphorous from a fluid. In particular, the clay or modified clay having a particular constitution provides enhanced phosphorous adsorption.

### BACKGROUND

The increased load of phosphorus as a pollutant in the environment has been a matter of concern for decades. Phosphorous in excessive amounts in soils from fertilizer application, livestock manure and wastewater runoff are leaching into downstream freshwater ecosystems which causes eutrophication and overgrowth of nuisance plant species and algae by increasing the biological productivity of surface waters (Boeykens et al., 2017, Eutrophication decrease: phosphate adsorption processes in presence of nitrates. Journal of Environmental Management, 203, 888-895, incorporated herein by reference). Although eutrophication is a natural process, it can be sped up by changes in the land use of a watershed that increase the amount of nutrients added to an aquatic system (Mateus and Pinho, 2010, Phosphorus removal by expanded clay—Six years of pilot-scale constructed wetlands experience. Water environment research, 82, 128-137, incorporated herein by reference). The Environmental Protection Agency has identified eutrophication as the main problem in the United States surface waters that have impaired water quality (Nutrient Pollution, 2019, https://www.epa.gov/nutrientpollution, incorporated herein by reference). Similarly, according to a Canadian national watershed report by WWF (2017) (https://data.skeenasalmon.info/id/dataset/wwf-watershed-report-2017/resource/d54eb998-fe23-46f1-9e58-fcd0afe3c862), 42 of the 67 sub-watersheds with known water quality data in Canada have “fair” or “poor” water quality. Effects of nutrient overloading in lakes range from increased biomass to composition change in aquatic food webs, to decreases in water transparency and oxygen levels, to declining fish populations, to toxic algal blooms that can cause death in animals and health issues in humans (Smith et al., 1999, Eutrophication: impacts of excess nutrient inputs on freshwater, marine, and terrestrial ecosystems. Environmental pollution, 100, 179-196, incorporated herein by reference).

The use of pesticides and herbicides along with fertilizers have escalated significantly worldwide in order to meet the demand of agricultural products for the growing global population. Among them glyphosate based herbicides are the most widely used herbicides comprising 60% of the global sale (Villamar-Ayala et al. 2019, Critical Reviews in Environmental Science and Technology 49: 1476-1514, incorporated herein by reference).

Glyphosate—a phosphonic acid with the formula C3_{H8}NO5_{P}, also known as N-(phosphonomethyl) glycine—is a broad-spectrum, non-selective and post-emergent herbicide used in both agricultural and non-agricultural lands worldwide. Since 1974, approximately 8.6 billion kg of glyphosate have been applied globally with 1.06 billion kg being applied in the United States (US) alone over the last decade (Benbrook 2016, Environmental Sciences Europe 28: 3, incorporated herein by reference). The global market growth rate of glyphosate reached US$8.79 billion by 2018, from the previous US$5.46 billion in 2012 (Richmond 2018, Journal of Environmental Studies and Sciences 8: 416-434, incorporated herein by reference).

With this huge increase in glyphosate use, the contamination of soil surfaces and water resources associated to it has also increased due to the run-off or leaching after its application, or even during its preparation and transportation (Hu et al. 2011, Desalination 271: 150-156, incorporated herein by reference). Moreover, the contamination by glyphosate and its impact on the environment has recently raised a huge concern as many recent studies have found different toxicological effects of glyphosate encompassing endocrinal, mutagenic, carcinogenic and neurologic problems (Myers John Peterson et al. 2016a, Environmental Health 15: 1-13, incorporated herein by reference).

In addition to these eco-toxicological concerns, another harmful effect of increased glyphosate use is the addition of phosphorus (P) to agricultural landscapes, which influences the P cycle and accumulation in soil. This causes P to leach into surrounding freshwater systems causing nutrient overloading or eutrophication in surface waters (Aparicio et al. 2013, Chemosphere 93: 1866-1873, incorporated herein by reference).

Eutrophication is the process where overloading of minerals and nutrients (i.e., P and N) to water bodies induces excessive growth of plants and algae creating many adverse effects on the environment, such as toxic algal blooms, biodiversity loss, depletion of dissolved oxygen leading to fish kills, closure of aquatic recreational sites, and many more (Smith and Schindler 2009, Trends in ecology & evolution 24: 201-207, incorporated herein by reference). Although pesticides are usually not considered an anthropogenic source of P, a recent study argues that due to the rapid increase in the application rate of glyphosate (almost six times higher per square km over the last two decades across the US), it has a significant role in eutrophication by adding anthropogenic P to watersheds (Hebert et al. 2019, Frontiers in Ecology and the Environment 17: 48-56, incorporated herein by reference). Especially in areas where glyphosate resistance crops are grown (Hebert et al. 2019, incorporated herein by reference).

Nitrogen and phosphorous both affect eutrophication, but phosphorus has been cited as a vital and limiting nutrient in freshwater system where a phosphate concentration as low as 0.02 mg L-1 in a water reservoir is sufficient to stimulate algal growth (Kilpimaa et al., 2015, Physical activation of carbon residue from biomass gasification: Novel sorbent for the removal of phosphates and nitrates from aqueous solution. Journal of Industrial and Engineering Chemistry, 21, 1354-1364, incorporated herein by reference) and a decrease in phosphorus can effectively control eutrophication in coastal and freshwater systems (Smith, 2003, Eutrophication of freshwater and coastal marine ecosystems a global problem. Environmental Science and Pollution Research, 10, 126-139, incorporated herein by reference). Therefore, phosphorous discharged from municipal and industrial wastewater treatment plants must be controlled to control eutrophication of surface waters. Different methods and technologies are known to remove phosphorous from contaminated water, but the disadvantages of these methods are mainly the increased cost of the used chemicals and the increase of sludge volume which requires special methods for dewatering, treatment, and safe final disposal.

There is a need in the art for a product for use in the removal of phosphorous containing compounds, such as, for example and without limitation, phosphate, glyphosate and the like, from fluids, such as, for example and without limitation, water. In addition, there is a need in the art for a process for preparation of such a product. Moreover, there is a need in the art for a method for removal of phosphorous containing compounds from a fluid using a product.

### SUMMARY OF THE INVENTION

In one aspect, the specification relates to a clay or clay absorbent, the clay containing:

kaolinite from 20-40 wt. %;

illite from 15-30 wt. %;

pigeonite from 5-15 wt. %; and

quartz up to a maximum of 40 wt. %,

wherein the clay is for use as an agent for reducing concentration of phosphorous in a fluid.

In another aspect, the specification relates to a method of treatment for reducing the concentration of phosphorous in a fluid, the method containing the steps of contacting the fluid with a clay, as disclosed herein.

In still another aspect, the specification relates to a method of manufacture of a clay, as disclosed herein.

Reference will now be made, by way of example, to the accompanying drawings which show example embodiments of the present application, and in which:

### BRIEF DESCRIPTION OF THE DRAWINGS

Reference will now be made, by way of example, to the accompanying drawings which show example embodiments of the present application, and in which:

FIG. 1 is an X-ray diffraction of the raw clay sample collected from natural deposit;

FIG. 2 is an SEM image of the raw clay sample which was used for the preparation of modified clay;

FIG. 3 shows a thermogravimetric analysis of the raw clay sample (with 10° C./min heating rate, in N₂ atmosphere).

FIG. 4 shows a process flow diagram for processing of natural clay (1-2-3-4-5-6-7); calcinated clay (1-2-3-4-5-5A-6-7); natural granulated clay (1-2-3-4-5-6-6A-7) and calcinated granulated Clay (1-2-3-4-5-5A-6-6A-7).

FIG. 5 shows the column designed for the adsorption study with calcinated clay granules and Zr modified clay granules in a continuous system.

FIG. 6 shows the breakthrough curve in Continuous P removal study by A) calcinated clay granules; and B) Zr modified clay granules.

Similar reference numerals may have been used in different figures to denote similar components.

### DESCRIPTION OF EXAMPLE EMBODIMENTS

The inventors have determined that clay having a particular composition of minerals can be effective in removal of phosphorous from a fluid. The clay can be used a natural clay, or a modified clay, and can function as adsorbent. As such, the clay disclosed herein is an adsorbent clay.

In one aspect, the specification relates to a clay, the clay containing:

kaolinite from 20-40 wt. %;

illite from 15-30 wt. %;

pigeonite from 5-15 wt. %; and

quartz up to a maximum of 40 wt. %,

wherein the clay is for use as an agent for reducing concentration of phosphorous in a fluid.

The term “clay” is not particularly limited and should be known to a person of skill in the art. Clay is a type of fine-grained natural soil material containing clay minerals. Clays develop plasticity when wet, due to a molecular film of water surrounding the clay particles, but become hard, brittle and non-plastic upon drying or firing. Clay minerals are hydrous aluminium phyllosilicate minerals, composed of aluminium and silicon ions bonded into tiny, thin plates by interconnecting oxygen and hydroxide ions. The main groups of clays include kaolinite, montmorillonite-smectite, and illite. Chlorite, vermiculite, talc, and pyrophyllite are sometimes also classified as clay minerals. There are approximately 30 different types of “pure” clays in these categories, but most “natural” clay deposits are mixtures of these different types, along with other weathered minerals. The clay used herein can be a natural clay, or a modified clay, as disclosed herein, for removal of phosphorous from a fluid.

The term “kaolinite” is not particularly limited and should be known to a person of skill in the art. In one embodiment, for example and without limitation, kaolinite refers to a clay mineral, with the chemical composition Al₂Si₂O₅(OH)₄. In one embodiment, the amount of kaolinite present in the clay is from, for example and without limitation, 20-40 wt. %. In another embodiment, the amount of kaolinite present in the clay is from, for example and without limitation, 20-35 wt. %, 20-30 wt. %, 20-25 wt. %, 25-40 wt. %, 25-35 wt. %, 25-30 wt. %, 30-40 wt. %, or 30-35 wt. %. In a further embodiment, the amount of kaolinite present in the clay is about, for example and without limitation, 20 wt. %, 21 wt. %, 22 wt. %, 23 wt. %, 24 wt. %, 25 wt. %, 26 wt. %, 27 wt. %, 28 wt. %, 29 wt. %, 30 wt. %, 31 wt. %, 32 wt. %, 33 wt. %, 34 wt. %, 35 wt. %, 36 wt. %, 37 wt. %, 38 wt. %, 39 wt. %, or 40 wt. %.

The term “illite” is not particularly limited and should be known to a person of skill in the art. In one embodiment, for example and without limitation. In one embodiment, for example and without limitation, illite is a group of closely related non-expanding clay minerals, and considered a secondary mineral precipitate, and an example of a phyllosilicate, or layered alumino-silicate. The chemical formula for illite is given as (K, H₃O)(AL, Mg, Fe)₂(Si, Al)₄O₁₀(OH)₂.(H₂O). In one embodiment, the amount of illite present in the clay is from, for example and without limitation, 15-30 wt. %. In another embodiment, the amount of illite present in the clay is from, for example and without limitation, 15-25 wt. %, 15-20 wt. %, 20-30 wt. %, 20-25 wt. %, or 25-30 wt. %. In a further embodiment, the amount of illite present in the clay is about, for example and without limitation, 15 wt. %, 16 wt. %, 17 wt. %, 18 wt. %, 19 wt. %, 20 wt. %, 21 wt. %, 22 wt. %, 23 wt. %, 24 wt. %, 25 wt. %, 26 wt. %, 27 wt. %, 28 wt. %, 29 wt. %, or 30 wt. %.

The term “pigeonite” is not particularly limited and should be known to a person of skill in the art. In one embodiment, pigeonite is a mineral in the clinopyroxene subgroup of the pyroxene group. It has a general formula of (Ca,Mg,Fe)(Mg,Fe)Si₂O₆. The calcium cation fraction can vary from 5% to 25%, with iron and magnesium making up the rest of the cations. In one embodiment, the amount of pigeonite present in the clay is from, for example and without limitation, 5-15 wt. %. In another embodiment, the amount of pigeonite present in the clay is from, for example and without limitation, 5-10 wt. %, or 10-15 wt. %. In a further embodiment, the amount of pigeonite present in the clay is about, for example and without limitation, 5 wt. %, 6 wt. %, 7 wt. %, 8 wt. %, 9 wt. %, or 10 wt. 11 wt. %, 12 wt. %, 13 wt. %, 14 wt. %, 15 wt. %, 16 wt. %, 17 wt. %, 18 wt. %, 19 wt. %, or 20 wt. %.

The term “quartz” is not particularly limited and should be known to a person of skill in the art. In one embodiment, quartz is a hard, crystalline mineral composed of silica (silicon dioxide). The atoms are linked in a continuous framework of SiO4 silicon-oxygen tetrahedra, with each oxygen being shared between two tetrahedra, giving an overall chemical formula of SiO₂. In one embodiment, the amount of quartz present in the clay is, for example and without limitation, up to a maximum of 40 wt. %. In another embodiment, the amount of quartz present in the clay is, for example and without limitation, up to a maximum of 35 wt. %, 30 wt. %, 25 wt. %, 20 wt. %, or 15 wt. %. In a further embodiment, the quartz is absent or substantially absent from the clay, or present as an impurity at levels close to 0 wt. %.

The term “nontronite” is not particularly limited and should be known to a person of skill in the art. In one embodiment, nontronite is the iron(III) rich member of the smectite group of clay minerals. Nontronites typically have a chemical composition containing of more than ˜30% Fe₂O₃ and less than ˜12% Al₂O₃ (ignited basis). A typical structural formula for nontronite is Na_{0.3}Fe₂((Si,Al)₄O₁₀)(OH)₂.H₂O. In one embodiment, the amount of nontronite present in the clay is from, for example and without limitation, 1-5 wt. %. In another embodiment, the amount of nontronite present in the clay is about, for example and without limitation, 1 wt. %, 2 wt. %, 3 wt. %, 4 wt. %, or 5 wt. %.

The term “dolomite” is not particularly limited and should be known to a person of skill in the art. In one embodiment, dolomite is an anhydrous carbonate mineral composed of calcium magnesium carbonate, ideally CaMg(CO₃)₂. In one embodiment, the amount of dolomite present in the clay is from, for example and without limitation, 1-8 wt. %. In another embodiment, the amount of nontronite present in the clay is about, for example and without limitation, 1 wt. %, 2 wt. %, 3 wt. %, 4 wt. %, 5 wt. %, 6 wt. %, 7 wt. %, or 8 wt. %.

In addition to the minerals noted herein, the clay as disclosed herein may further contain aluminum, calcium, iron potassium, magnesium or sulfur. The aluminum, calcium, iron potassium, magnesium or sulfur does not relate to elemental aluminum, calcium, iron potassium, magnesium or sulfur, but rather to compounds, such as, for example and without limitation, inorganic compounds, such as, for example and without limitation, salts of aluminum, calcium, iron potassium, magnesium or sulfur. In one embodiment, for example and without limitation, these other species can be up to a maximum of 15 wt. %, without significantly or detrimentally affecting the performance of the clay.

The term “phosphorous” as used herein is not particularly limited and should be known to a person of skill in the art. In the subject specification, the term phosphorous relates to a molecular species containing phosphorous. In one embodiment, the term phosphorous relates to an inorganic phosphorous species, such as, for example and without limitation, phosphate (PO₄⁻³), phosphite (HPO₃⁻²), and the like. In another embodiment, the term phosphorous relates to organic phosphorous species, such as, for example and without limitation, glyphosate (C₃H₈NO₅P).

The term “fluid” as used herein is not particularly limited and should be known to a person of skill in the art. In the subject specification, the term fluid relates to, for example and without limitation, liquids. In another embodiment, for example and without limitation, the term fluid relates to water, such as, lake water.

The clay as disclosed herein can be used as a natural clay. In one embodiment, the natural clay can be cleaned to remove debris, such as, for example and without limitation, gravel from the natural clay before use. In another embodiment, the natural clay can be dried before use. The process for drying is not particularly limited and should be known to a person of skill in the art. In one embodiment, for example and without limitation, the natural clay is heated for a period of time before use. In a particular embodiment, for example and without limitation, the natural clay is heated from 100-150° C. The time period for drying is not particularly limited, and should be known or can be determined by a person of skill in the art. In one embodiment, the natural clay is dried from about 4-48 hours to remove water.

In another embodiment, the clay is grounded and sieved prior to use.

The process for grinding or sieving is not particularly limited, and should be known to a person of skill in the art, or can be determined.

In another embodiment, as disclosed herein, the clay can be modified prior to use. In one embodiment, the clay can heat treated, such as, for example and without limitation, by calcination of the clay. In another embodiment, for example and without limitation, the clay can be modified with other species. In still another embodiment, the clay can be modified by calcination and by modification with another species.

The process for calcination as disclosed herein is not particularly limited. Calcination relates to a process of heating a substance to a high temperature but below the melting or fusing point, causing loss of moisture, reduction or oxidation, and dissociation into simpler substances. In one embodiment, for example and without limitation, the clay is calcinated at a temperature of between at least 400° C. to 700° C. In another embodiment, the clay is calcinated at a temperature of between 450° C. to 650° C. In a further embodiment, the clay is calcinated at a temperature of 600° C.

The time period for calcination is not particularly limited and can be varied depending upon conditions. In addition, such time period can be determined by a person of skill in the art. In one embodiment, for example and without limitation, the time period for calcination is from about 30 minutes to about 48 hours. In a further embodiment, for example and without limitation, the time period for calcination is from about 12 hours to about 36 hours. In a still further embodiment, for example and without limitation, the time period for calcination is from about 24 hours. After calcination, the calcinated clay can be allowed to come to cool and come to room temperature.

As noted above, in one embodiment, for example and without limitation, the clay can be modified with other species. The modification of clay, either natural or modified, is not particularly limited, and can be determined by a skilled worker. In one embodiment, for example and without limitation, the clay was modified with zirconium or iron salts.

The modification process is also not particularly limited, and can be determined by a skilled worker. In one embodiment, for example and without limitation, the process involves treating the clay with a metal halide, such as, for example and without limitation, zirconium chloride or iron chloride. In another embodiment, for example and without limitation, the process involves treating the clay with, for example and without limitation, zirconium chloride solution. In a further embodiment, for example and without limitation, the clay with the zirconium chloride solution can be treated with an aqueous base, to achieve a basic medium and agitated for a period of time. The time period for agitation is not particularly limited and can be determined by a person of skill in the art. In one embodiment, for example and without limitation, the clay is agitated for at about 30 minutes, prior to separation of the clay from the solution. Separation can be carried out by, for example and without limitation, filtration or centrifugation. The separated and modified clay can be dried, for example and without limitation, in an oven at about, for example and without limitation, room temperature to about 150° C. for about 30 minutes to about 24 hours.

In one embodiment, the clay or modified clay can be granulated prior to use. The process of granulation is not particularly limited and should be known to a person of skill in the art. In one embodiment, the clay or modified clay can be formed or shaped, such as being, for example and without limitation, granulated or pelletized using binders or fillers, prior to use. In a particular embodiment, for example and without limitation, the clay or modified clay is treated with an agent, such as, for example and without limitation, sodium alginate (SA) solution. The treatment step can involve, for example and without limitation, agitation of the sodium alginate solution for a period of time, such as, for example and without limitation, one to five hours, at room temperature. Once completed, the SA treated clay or modified clay can be reacted with a cross-linking agent, such as, for example and without limitation, calcium chloride, leading to formation of granules. In one embodiment, for example and without limitation, the granules formed can be heat treated under conditions similar to a calcination process as described above.

The method of treatment using the clay, or modified clay, is not particularly limited, and can be determined by a person of skill in the art. In one embodiment, for example and without limitation, the method involves contacting the clay, or modified clay, with the fluid for a sufficient period of time to allow for phosphorous adsorption. In one embodiment, for example and without limitation, the fluid is agitated to allow for mixing of the fluid with the clay, or modified clay. In another embodiment, for example and without limitation, the clay or modified clay is placed in a device, such as, for example and without limitation, a tubing, and having an inlet and an outlet, and permitting fluid flow from the inlet to the outlet, whereby the fluid contacts the clay or modified clay.

### EXAMPLES

The following examples are illustrative and non-limiting and represent specific embodiments of the present invention

### Example 1: Preparation and Characterization of Natural Clay Sample Collected from Natural Deposits

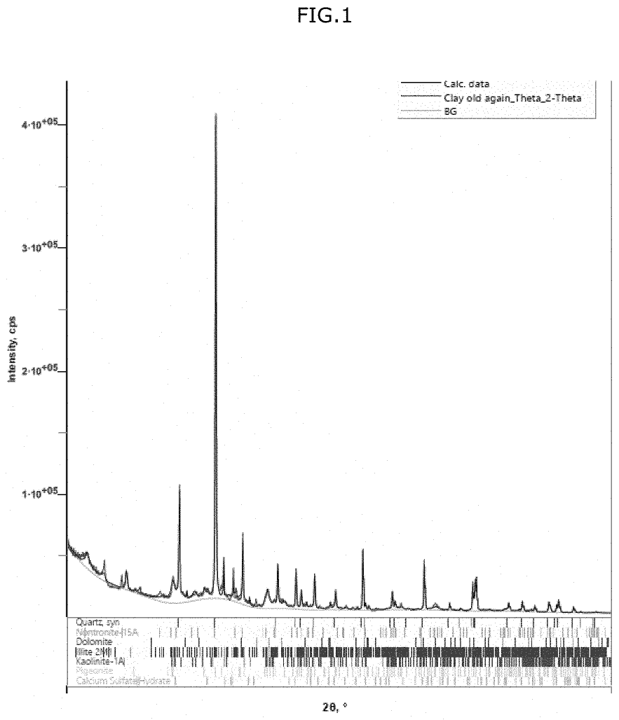

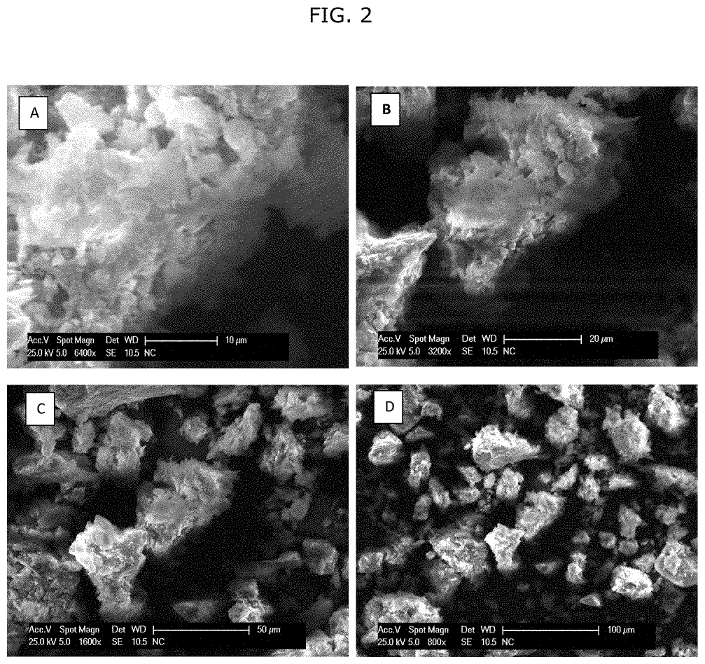

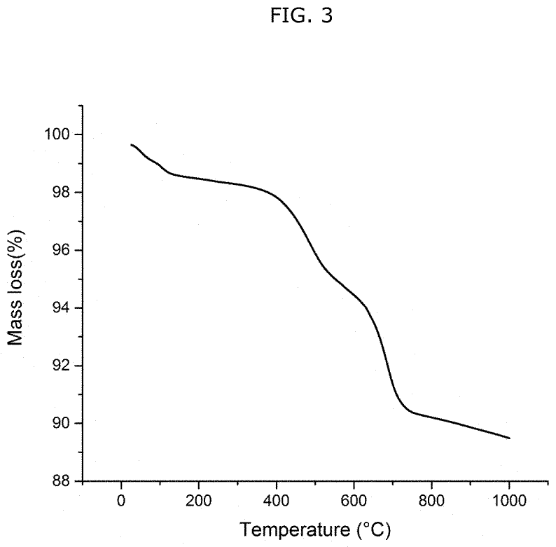

The following is an example of the preparation of the natural sample after collecting from natural deposits, and characterization of the clay sample which can be modified, prior to utilization. The gravel and debris present in the raw clay collected from natural clay pits, was separated by hand and then air-dried in an oven at 105° C. for 24 hours. Then the dried samples were hand ground by mortar and pestle, sieved to 0.053 mm (ASTM-E11), and the final powdered sample was packed in a plastic zipper packet for further use. Then different physiochemical properties of the natural samples were determined. The crystalline structure of the adsorbents was characterized using X-ray diffraction (parameters: CuKα [λ=1.54059 Å], 3°<2θ<90° with step width of 0.02°, 40 kV, 15 mA) (Rigaku Miniflex 600 6G). The XRD patterns of the raw sample is shown in FIG. 1. The composition of the mineralogical phase of the sample is enclosed in Table 1. The XRF analysis (Rigaku, NEX-QC+EDXRF) was employed to determine chemical composition of the samples. The chemical composition from XRF is mentioned in Table 2. The surface morphology of samples was obtained by scanning electron microscope (SEM, PHILIPS XL 30) operating at 10 keV of acceleration voltage as shown in FIG. 2. Thermogravimetric Analysis (TGA) was performed on the clay samples by Discovery TGA (TA Instruments 954000.901) which is shown in FIG. 3. Brunaur-Emmett-Teller (BET) specific surface areas and the pore distribution of samples were measured using Autosorb-1 device (Quantachrome instrument) at 77K.

TABLE 1
XRD mineralogical phase analysis of the
raw clay sample using Rietveld method

| Phase name | Percentage (wt. %) |
|---|---|
| Quartz —SiO₂ | Max 40 |
| Kaolinite-1A —Al₂ (Si₂O₅) (OH)₄ | 20-40 |
| Illite -2M1 - | 15-30 |
| (K,H₃O)(Al,Mg,Fe)₂(Si,Al)₄O₁₀(OH)₂,(H₂O) | |
| Pigeonite- Ca_{0.12}Fe_{0.85}Mg_{1.03} (Si₂O₆) | 5-15 |
| Nontronite 15-A (Smectite clay)- | 1-5 |
| Na_{0.3}Fe₂((Si,Al)₄O₁₀)(OH)₂•H₂O | |
| Dolomite- CaMg(CO₃)₂ | 1-8 |

TABLE 2
Chemical composition of raw clay by XRF analysis

| Analyte | Result (%) |
|---|---|
| SiO₂ | 64.39 |
| Al₂O₃ | 12.09 |
| Fe₂O₃ | 6.25 |
| CaO | 6.11 |
| K₂O | 3.52 |
| MgO | 2.84 |
| SO₃ | 2.48 |
| TiO₂ | 0.94 |
| Na₂O | 0.67 |
| P₂O₅ | 0.26 |
| BaO | 0.13 |
| Cr₂O₃ | 0.05 |
| MnO | 0.05 |
| ZnO | 0.04 |
| ZrO₂ | 0.03 |
| SrO | 0.02 |
| Rb₂O | 0.01 |

### Example 2: Preparation of the Modified Clay by Calcination Method

The following is an example of the preparation of the modified clay according to an embodiment. The sieved clay powdered sample from Example 1, was calcinated at least 450° C., (and in another embodiment at 600° C.) for 24 h in an electric furnace using a controlled heating program with a heating rate 6° C./min to prepare the modified clay. In other embodiments, the clay is heated at a heating rate of from 5° C./min to 20° C./min. After 24 hours, the samples were taken out of the furnace and kept under a glass desiccator to let it cool down to room temperature and then the final modified calcinated sample was stored in glass tubes for further use.

### Example 3: Preparation of the Modified Clay with Zirconium Salt

In another embodiment, the clay from example 1, can be further modified by addition of Zirconium (Zr) salt. For example, modifying the clay with Zirconium salt, five grams of ZrCl₄ salt was dissolved in 100 mL of deionized water separately and then 10 g of the natural clay sample was added into the solution. Then, the suspension was stirred magnetically for 1.5 h. After that, a 1 mol/L NaOH solution was slowly added dropwise to the suspension. During the addition of the NaOH solution, the suspension was kept under magnetic stirring till the solution pH reach 10. After that, the suspensions were stirred magnetically for 1 h and then the Zr modified clay was separated by centrifugation, washing repeatedly with deionized water, and finally were dried in a 105° C. oven. The obtained dry materials were analyzed by ICP-OES after acid digestion to check how much Zr was attached onto the clay (Table 3) and rest of them was stored in desiccator for further use.

TABLE 3
Zr attachment onto the clay (by ICP-OES after acid digestion)

| Adsorbent Type | Zr amount (mg/kg) |
|---|---|
| Natural Clay | 42.4 |
| Zr modified clay | 123430 |

### Example 4: Preparation of Granulated Clay from Powder Form

In a further embodiment, the powder clay from example 1 and 3 was granulated and shaped, to form the granulated modified clay by using a modified method from previous studies (Siwek et al., 2019, Water, 11, 633; Charkhi et al., 2012, Powder Technology, 231, 1-6; both incorporated herein by reference). For example, to shape the adsorbents, Sodium alginate (SA) solution (2%, w/v) was prepared using distilled water under constant stirring at room temperature until it turned into a homogenous mixture. Then, 10 g of each clay was placed individually in SA solutions and agitated for two hours to achieve uniform dispersion. After that, the polymer solutions containing SA/clay and SA/ZrMC were inserted into a 10 -mL syringe and then extruded into a cross-linking solution containing calcium chloride (0.15 M) with constant stirring. The granules were produced instantly but kept there for an additional hour for a complete cross-linking reaction. Then the granules were washed with distilled water and then kept at room temperature for 24 hours. Then for the final drying step, the granules were kept at 600° C. for 24 h in an electric furnace using a controlled heating program with a heating rate of 6° C./min to decompose the alginate content of the granules. In other embodiments, the clay is heated at a heating rate of from between 5° C./min to 20° C./min.

### Example 5: Phosphate Batch Adsorption Experiments with Natural and Calcinated Modified Clay

Following is an example for batch adsorption protocol of the adsorbents following to an embodiment. From each adsorbent in example 1 and 2, 0.5 g sample was weighed and transferred to a 50-mL centrifuge tube and 20 mL of 20 mg/L P solution was added. The mixture agitated for 24 hours at room temperature using a rotary shaker. Then, the supernatants were collected after centrifuging the mixtures at 4000 rpm for 10 min and kept for further analysis to determine the P concentration by ICP-OES and using the following equation, the percent removal of P was determined by the adsorbents and the results were mentioned in Table 4:

$$\% removal = \frac{Co - Ct}{Co} \times 100 \% \qquad Equation 1$$

where Co: initial concentration of P, Ct: equilibrium concentration of P (both in mg/L)

TABLE 4
Phosphate removal percentages in the presence of different
adsorbents; where initial P concentration = 20
mg/mL, contact time = 24 h, adsorbent dosage = 50 g/L

| Adsorbent Type | % Removal |
|---|---|
| Natural clay | 65.1 |
| Calcinated clay(600° C.) | 98.5 |
| Calcinated clay (450° C.) | 95.5 |
| Calcinated granulated clay (600° C.) | 92.5 |

### Example 6: Phosphate Batch Adsorption Experiments with Zr Modified Powder and Granulated Sample

Following is an example for batch adsorption protocol of the adsorbents following to an embodiment. From example 3 and example 4, 0.03 g of each zirconium modified powder and granulated sample was weighed separately and transferred to a 50-mL centrifuge tube and 20 mL of 20 mg/L P solution was added into each tube. Then, the mixtures were agitated for 24 hours at room temperature using a rotary shaker. Then, the supernatants were collected after centrifuging the mixtures at 4000 rpm for 10 min and kept for further analysis to determine the P concentration by ICP-OES and using the equation 1, the percent removal of P was determined by the adsorbents and the results were mentioned in Table 5.

TABLE 5
Phosphate removal percentages in the presence of different
adsorbents; where initial P concentration = 20
mg/mL, contact time = 24 h, adsorbent dosage = 1.5 g/L

| Adsorbent Type | % Removal |
|---|---|
| Zr modified clay | 85.9 |
| (non-heat treated) | |
| Zr modified granulated clay | 96.8 |
| (heat treated at 600° C.) | |

### Example 7: Determination of the Maximum Phosphate Adsorption Capacity of Calcinated Modified Clay

Following is an example for batch adsorption protocol of determining maximum P adsorption capacity by the adsorbents following to an embodiment. Maximum sorption capacity of the samples (from example 1 and 2) with respect to P were examined. 1 M Ammonium dihydrogen phosphate solution (NH₄H₂PO₄) was used as the synthetic source of phosphorous. Sample tubes were shaken at room temperature for 24 hours on a rotating shaker. After 24 h, the solutions were centrifuged, supernatants were kept for analysis and the spent adsorbents were washed with DI water for 3 times. Finally, the washed adsorbents were dried at 55° C. for 3 days and then the adsorbents (before and after the adsorption) were digested using reverse aqua regia method (Modified version of EPA 305013 method) (USEPA 1996) and analyzed by ICP-OES (Agilent SVDV 5100 ICP-OES) to determine the P content onto the adsorbents. From the difference of the P composition onto the adsorbents before and after the adsorption, the maximum P sorption capacity were calculated for the adsorbents and mentioned in Table 6.

TABLE 6
Maximum P adsorption capacity of different adsorbents
(by ICP-OES after acid digestion)

| | Maximum P Adsorption |
|---|---|
| Adsorbent Type | capacity (mg P/g) |
| Natural clay | 5.89 |
| Natural clay | 19.85 |
| (calcinated@450° C.) | |
| Granulated Natural clay | 45.94 |
| (calcinated@600° C.) | |

Example 8: Determination of the Maximum Phosphate Adsorption Capacity of Zirconium Modified Clay

Following is an example for batch adsorption protocol of determining maximum P adsorption capacity by the adsorbents following to an embodiment. Maximum sorption capacity of the Zr modified sample in example 3, with respect to P was examined. 1 M Ammonium dihydrogen phosphate solution (NH₄H₂PO₄) was used as the synthetic source of phosphorous. Sample tubes were shaken at room temperature for 24 hours on a rotating shaker. After 24 h, the solutions were centrifuged, supernatants were kept for analysis and the spent adsorbents were washed with DI water for 3 times. Finally, the washed adsorbents were dried at 55° C. for 3 days and then the adsorbents (before and after the adsorption) were analyzed by XRF (Rigaku, NEX-QC+EDXRF) to determine chemical composition of the samples and from the difference of the P content before and after the adsorption the maximum P attached to the adsorbents surface after the adsorption process were determined and the results are mentioned in Table 7.

TABLE 7
Maximum P adsorption capacity of different adsorbents (by XRF)

| | Maximum P Adsorption |
|---|---|
| Adsorbent Type | capacity (mg P/g) |
| Zr modified clay (non-heat | 41.2 |
| treated) | |
| Zr modified granulated clay (heat | 44.9 |
| treated at 600° C.) | |

### Example 9: Calculation of Adsorbent Required Based on the Initial P Concentration in Wastewater and Maximum P Adsorption Capacity

### Low level of P concentration (0.1 mg/L)

According to the adsorption capacity of the adsorbent, reducing lake water concentration from 0.1 mg/L to less than the critical level i.e. 0.05 mg/L or less,

1 kg Natural clay can treat,

$$\begin{matrix}5.89 mg P & 1000 g Adsorbent & 1 L Lake water \\ 1 g adsorbent & 1 Kg adsorbent & ( 0.1 - 0.05 ) mg P\end{matrix} \text{} = 117 , 800 L of Lake water$$

Similarly, 1 kg Calcinated (@600° C.) modified clay can treat,

$$\begin{matrix}20.48 mg P & 1000 g Adsorbent & 1 L Lake water \\ 1 g adsorbent & 1 Kg adsorbent & ( 0.1 - 0.05 ) mg P\end{matrix} \text{} = 409 , 600 L of Lake water$$

### Moderate/Moderate High Level of P Concentration (For example, Dairy Wastewater/Dairy Manure)

If the initial concentration of Total P is 50 mg/L then, 1 kg of natural clay can treat 235.6 L of wastewater and reduce the total concentration by 50%,

$$\begin{matrix}5.89 mg P & 1000 g Adsorbent & 1 L Lake water \\ 1 g adsorbent & 1 Kg adsorbent & ( 50 - 25 ) mg P\end{matrix} \text{} = 235.6 L of Lake water$$

And for the same treatment, 1 kg Calcinated (@600° C.) clay can treat,

$$\begin{matrix}20.48 mg P & 1000 g Adsorbent & 1 L Lake water \\ 1 g adsorbent & 1 Kg adsorbent & ( 50 - 25 ) mg P\end{matrix} \text{} = 819.2 L of Lake water$$

In summary, Table 8 shows the amount of adsorbent required to treat 1000 L of different phosphate contaminated water:

TABLE 8
Adsorbent required to treat different levels of P loaded wastewater

| | Amount of | |
|---|---|---|
| | Natural Clay | Amount of calcinated |
| Wastewater type | required | (@600° C.) clay required |
| 1000 L Lake water | 8.48 g | 2.44 g |
| (0.1 ppm initial P) | | |
| 1000 L Dairy wastewater | 4.24 kg | 1.22 kg |
| (50 ppm initial P) | | |

### Example 10: Process Flow Diagram

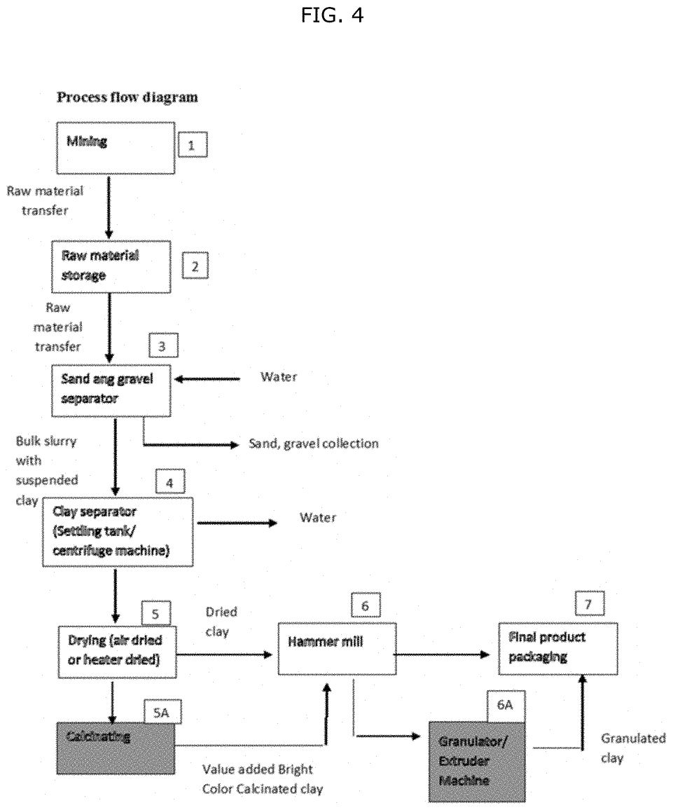

The process flow diagram (FIG. 4) shows the processing of the clay. Wet processing of natural clay will begin with blunging to produce a slurry, which then will be fractionated into coarse and fine fractions using centrifuges, hydrocyclones, or hydroseparators. The sand, gravel-rocks and other course particles will be separated from this unit and the slurry with fine suspended clay will enter to the next unit, where clays will be separated from water either by settling tank or centrifuges. Then the dewatered slurry material will be dried in air or in heater dryer. Following the drying step, the clay may be calcined to increase its adsorption capacity. Multiple hearth furnaces, flash and rotary calciners are most often used to calcine clay. Then the dried and/or the calcinated clay will enter to the hammer mill to make grinded clay as final product. Or they can be further processed by using a granulator/extruder machine for shaping granulated clay as final product.

In FIG. 4, four final products have been proposed in the flow diagram.

They are natural clay, calcinated clay, natural granulated/shaped clay and calcinated granulated/shaped clay. The possible flow path for each of the product has been specified.

### Example 11: Optimization Study Using DOE and RSM Statistical Methods

In this work, a full factorial design of experiment (DOE) was developed using Minitab software (version 18, Minitab, Inc., USA) to examine the effects of four independent variables on phosphorus removal by calcinated granulated clays prepared in Example 4. These four variables were adsorbent dose, initial concentration, pH, and contact time. DOE is a method for analyzing any response that varies in response to one or more independent factors. Two-level full factorial DOE is a special subset of general factorial designs as it has only two levels of each variable. These experiments are designated for 2^{k} runs, where k is the number of variables and 2^{k} represents the number of unique runs in each replicate of the design. The 2^{k} experiments can describe all of the variables under investigation as well as resolve two-factor and higher-order interactions when all of the runs are done in random order (Mathews, Design of experiments with Minitab. Milwaukee, Wis.: Quality Press; 2005; https://d1wqtxts1xzle7.cloudfront.net/44283092/Mathews Paul G.—Design of Experiments with MINITAB-American Society for Quality ASQ 2005-with-cover-page-v2.pdf?Expires=1645735153&Signature=fawOAThxwUmoVOy2˜x7i-1B˜SpbGX8Ui4OszB5lyeMCsQ6jzOI7Gz9RSJvJa77GpDyq₆₁RzaVixPmkrP˜gOrjxJud1 SQQBrh1K˜hqdFL14EEhyEuKG˜KSY0aEg32bduUV˜IxgCrHB2IXXBarMtDRQGI73dMc qym7pLrC2U-awiZwTMtwxOxMLuzpaIcC2LM HHch˜EF1FKh-fWWWg5sKXKrD˜BBzIKpf9QHlSzdNRm7ofbUA-B8swUHisiVz7E9GoWauLc˜CNrws5zKLwtdXHEAFtBVkaoXQAyxYkdh˜hgn-AC4SXZzdF-pEciF7bqIKOI4qqghOf9XRmnYpb0YVkbg &Key-Pair-Id=APKAJLOHF5GGSLRBV4ZA). Using Minitab software, in this work, a 24 complete factorial design of experiment (DOE) was developed to investigate the effects of four independent factors on P removal by granulated calcinated clay and granulated zirconium modified clay. The independent variables of experimental conditions were applied as indicated in Table 9 based on preliminary test findings. For each type of adsorbent, the number of total runs was 54, including 3 replicates and center points. The parameters involved in these experiments were then analyzed by using response surface methodology (RSM) on Minitab software.

TABLE 9
Independent variables of the experimental design

| | | Coded Levels | | | | | |
|---|---|---|---|---|---|---|---|
| | | Calcinated | | | Zr modified | | |
| Independent Variable | Factor | granulated clay | | | granulated clay | | |
| | | −1 | 0 | +1 | −1 | 0 | +1 |
| Initial Concentration | A | 5 | 17.5 | 30 | 5 | 17.5 | 30 |
| (mg/L) | | | | | | | |
| Adsorbent dose (g/L) | B | 10 | 25 | 50 | 0.2 | 0.4 | 1 |
| Contact time (hour) | C | 1 | 8 | 16 | 1 | 8 | 16 |
| pH | D | 5 | 7 | 9 | 5 | 7 | 9 |

To perform the DOE, different concentrations of P solution were prepared by dissolving a known amount of Na₂HPO₄ salt in deionized water and the pH of the solutions was adjusted by 0.1 mol/L NaOH or HCl solution to the desired values. Then desired amounts of adsorbents were mixed with the desired concentration of 20 mL P solution in 50 mL plastic vials. The plastic vials were shaken by a rotating shaker at 100 rpm at room temperature for the targeted contact time. Then, the plastic vials were centrifuged at 4000 rpm for 10 min to settle fine clay particles and the supernatant solutions were collected for further analysis. The spent adsorbents were washed with DI water once and dried at 105° C. in an oven overnight. The filtered solutions were analyzed by ICP-OES to determine the P concentrations. The measured amounts of P were used to calculate the percent P removal efficiency.

After performing 54 sets of experiments for each type of clay, based on a full factorial design of four independent variables (initial conc, pH, time, and adsorbent dosage), the experimental results for P removal efficiency (%) ranged from 2.1 to 91.6%, and 31.2%-99.9% for Calcinated granulated clay and Zr modified granulated clay respectively. The optimal conditions to achieve the maximum removal efficiency for both clays have been presented in Table 10. Under these conditions, 91.5% and 99.9% maximum removal efficiency can be achieved by Calcinated granulated clay and Zr modified granulated clay, respectively with a composite desirability function of 0.977 & 0.998 (very close to 1), which indicated that the settings would most likely achieve the proposed maximum percent removal.

TABLE 10
Embodiment of conditions for P removal efficiency

| | Calcinated granulated | Zr modified granulated |
|---|---|---|
| | clay | clay |
| | (Maximum P removal | (Maximum P removal |
| Process variable | efficiency = 91.5%) | efficiency = 99.9%) |
| Initial Concentration | 5 | 30 |
| (mg/L) | | |
| Adsorbent dose (g/L) | 25 | 1 |
| Contact time (hour) | 16 | 16 |
| pH | 5 | 5 |

### Example 12: Column Experiment

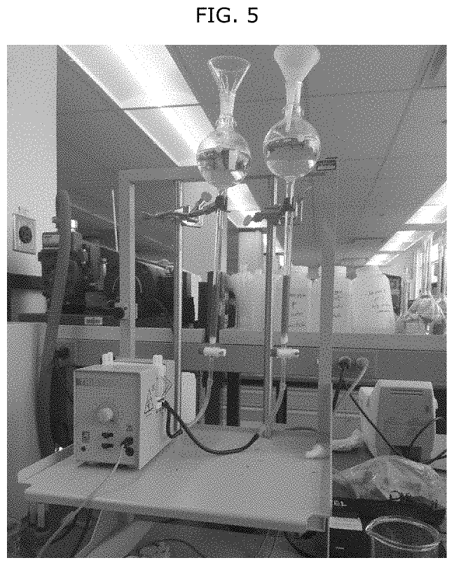

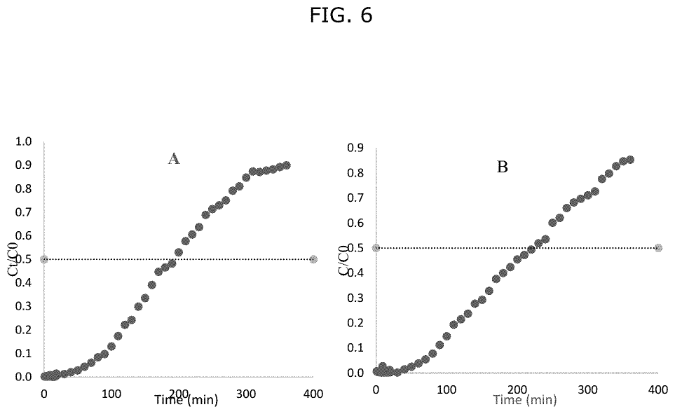

Following is an example for a continuous adsorption process to determine the feasibility and practical use of Calcinated granulated clay and Zr modified granulated clay for phosphorus removal. The fixed-bed column was designed using a glass burette (100 mm in length and 10 mm in internal diameter) with a 500 mL reservoir on top of it. Then the column was loaded with the adsorbents separately as shown in FIG. 5. A synthetic feeding solution (5.35 mg/L of P) was fed as a downward system, and by using a peristaltic pump, the speed of flow rate was adjusted to 10.0 mL/min (FIG. 5). In the first 20 minutes, 10 mL of the output solution was collected every minute to investigate the concentration profile at the start during this time. After 20 minutes, each 10 mL solution was collected every 10 minutes. All the collected output solution was analyzed for total P by ICP-OES. The breakthrough curves for the adsorbents in column experiments are represented in FIG. 6. It shows the loading behavior of phosphorus as it was removed in the fixed bed column and was expressed in terms of the ratio of the effluent phosphorus concentration to the influent phosphorus concentration (Ct/Co) as a function of time for a given bed height. As shown, the same trend was observed for both adsorbents with different capacities. When the adsorbents are not saturated at the start of the experiment, the phosphate ions in the feeding solution are completely absorbed by the adsorbent, and the concentration of P in the effluent solution is near to zero. The concentration of P in the output solution began to increase when the adsorbent had been saturated as a result of increasing adsorbent contact with the feeding solution. In both cases, the concentration of P in the outlet solution increased by increasing the time. For both adsorbents' column, the concentration of P in outlet solution increased very slowly and after 330 min (3300 mL) started to be flatted. The experiment continued up to 380 min (3800 mL) but still was below breakthrough concentration which indicates both adsorbents perform in column experiment very well.

Certain adaptations and modifications of the described embodiments can be made. Therefore, the above discussed embodiments are considered to be illustrative and not restrictive.

What is claimed is:

1. A clay, the clay comprising:
kaolinite from 20-40 wt. %;
illite from 15-30 wt. %;
pigeonite from 5-15 wt. %; and
quartz up to a maximum of 40 wt. %,
wherein the clay is for use as an agent for reducing concentration of phosphorous in a fluid.

2. The clay of claim 1, further comprising:
nontronite from 1-5 wt. %.

3. The clay of claim 1, further comprising:
nontronite from 1-5 wt. %, and dolomite from 1-8 wt. %.

4. The clay of claim 1, further comprising:
aluminum, calcium, iron potassium, magnesium or sulfur up to a maximum of 15 wt. %.

5. The clay of claim 1, wherein the phosphorous is an inorganic ionic phosphorous species.

6. The clay of claim 5, wherein the inorganic ionic phosphorous species is a phosphate ion.

7. The clay of claim 1, wherein the phosphorous is glyphosate.

8. The clay of claim 1, wherein the fluid is water.

9. The clay of claim 1, wherein the clay is a zirconium modified clay or an iron modified clay.

10. The clay of claim 1, wherein the clay has a Dₓ (90) of from 100-150 μm.

11. The clay of claim 1, wherein the clay is heat treated at a temperature between 400° C. and 800° C. over a period between 30 minutes to 48 hour.

12. The clay of claim 11, wherein the clay is granulated prior to heat treatment.

13. The clay of claim 11, wherein the clay is granulated after heat treatment.

14. A method of treatment for reducing the concentration of phosphorous in a fluid, the method comprising:
contacting the fluid with a clay, or modified clay, comprising:
kaolinite from 20-40 wt. %;
illite from 15-30 wt. %;
pigeonite from 5-15 wt. %; and
quartz up to a maximum of 40 wt. %.

15. A method of manufacture of a modified clay, the modified clay having kaolinite from 20-40 wt. %; illite from 15-30 wt. %; pigeonite from 5-15 wt. %; and quartz up to a maximum of 40 wt. %, the method comprising:
calcinating clay at a temperature of from 400 to 700° C. to form the modified clay.

16. The method of claim 15, comprising granulating the modified clay.
